(19) United States
(12) Patent Application Publication
(10) Pub. No.: US 2014/0008237 A1
(43) Pub. Date: Jan. 9, 2014

(54) METHOD OF PRODUCING HYDROCARBONS USING A FUEL CELL, AND FUEL STORAGE SYSTEM COMPRISING THE FUEL CELL

(71) Applicant: The University of Massachusetts, Boston, MA (US)

(72) Inventors: George W. Huber, Middleton, WI (US); Geoffrey A. Tompsett, Shrewsbury, MA (US); Sara K. Green, Belchertown, MA (US); Won Bae Kim, Gwangju (KR); Hyung Ju Kim, Gwanju (KR)

(73) Assignee: THE UNIVERSITY OF MASSACHUSETTS, Boston, MA (US)

(21) Appl. No.: 13/670,033

(22) Filed: Nov. 6, 2012

Related U.S. Application Data
(60) Provisional application No. 61/556,281, filed on Nov. 6, 2011.

(51) Int. Cl. C25B 3/04; H01M 16/00

(52) U.S. Cl. CPC C25B 3/04; H01M 16/003
USPC 205/343; 429/422

(57) ABSTRACT

A method of producing a hydrocarbon comprises providing electrical energy to a first fuel cell comprising an anode, cathode, and polymer electrolyte membrane; electrocatalytically oxidizing a hydrogen source by a first catalyst disposed on the anode to produce protons; and electrocatalytically reducing a hydrocarbonaceous source by the protons and a second catalyst disposed on the cathode to produce a hydrocarbon fuel composition, wherein the first and second catalysts are each a solid catalyst, and the anode and cathode are separated by the polymer electrolyte membrane.

### CROSS REFERENCE TO RELATED APPLICATION

This application is a nonprovisional of provisional U.S. Patent Application 61/556,281, filed on Nov. 6, 2011, the content of which is herein incorporated by reference in its entirety.

### BACKGROUND OF THE INVENTION

1. Field of the Invention

This invention relates to a method for production of hydrocarbons using a fuel cell, and particularly to the production of C₁-C₈ hydrocarbons by reduction of biomass-based feedstock.

2. Description of the Related Art

Energy storage using efficient and highly energy dense media pose challenges for the renewable energy industry. Present methods of energy storage, such as batteries, hydrodams (impounding water for the potential energy), flywheels, hydrogen storage cells, and other such storage media have disadvantages such as size, weight, lack of efficiency, and pose technical challenges. Storage of liquid fuels provides a convenient and efficient storage medium of size and weight.

Research conducted into the conversion of inexpensive feedstocks such as sugar alcohols into usable, more energy dense chemicals such as hydrocarbons has been carried out, such as that by Huber et. al. (Li, Ning; Huber, George, “Aqueous-phase Hydrodeoxygenation of Sorbitol with Pt/SiO₂—Al₂O₃: Identification of Reaction Intermediates,” Journal of Catalysis, 2010, 270, pp. 48-59). Aqueous-phase hydrodeoxygenation (APHDO) of sugar and sugar derived molecules to produce a range of alkanes and oxygenates. Specifically, the focus was the APHDO of sorbitol, a glucose derived polyol, platinum catalysts, was found to form hexanes, lighter alkanes and alcohols, and C₁-C₅ oxygenates. Such a product mixture is a high octane gasoline range renewable fuel substitute.

### BRIEF SUMMARY OF THE INVENTION

The shortcomings of the prior art are overcome and additional advantages are provided through, in an embodiment, a method of producing a hydrocarbon comprising providing electrical energy to a first fuel cell comprising an anode, cathode, and polymer electrolyte membrane; electrocatalytically oxidizing a hydrogen source by a first catalyst disposed on the anode to produce protons; and electrocatalytically reducing a hydrocarbonaceous source by the protons and a second catalyst disposed on the cathode to produce a hydrocarbon fuel composition, wherein the first and second catalysts are each a solid catalyst, and the anode and cathode are separated by the polymer electrolyte membrane.

In another embodiment, a method of producing a hydrocarbon comprises providing electrical energy to a first fuel cell comprising a first anode, first cathode, and first polymer electrolyte membrane; electrocatalytically oxidizing a hydrogen source by a first catalyst disposed on the first anode to produce protons; electrocatalytically reducing the protons by a second catalyst disposed on the first cathode to produce hydrogen; providing the hydrogen from the first fuel cell to a second fuel cell comprising a second anode, second cathode, and second polymer electrolyte membrane; providing electrical energy to the second fuel cell; electrocatalytically oxidizing the hydrogen by a third catalyst disposed on the second anode to produce protons; and electrocatalytically reducing a hydrocarbonaceous source by the protons and a fourth catalyst disposed on the second cathode to produce a fuel composition comprising a C₁-C₈ hydrocarbon, wherein the first, second, third, and fourth catalysts are each a solid catalyst, the first anode and first cathode are separated by the first polymer electrolyte membrane, and the second anode and second cathode are separated by the second polymer electrolyte membrane.

In another embodiment, a method of producing a hydrocarbon comprises providing electrical energy to a fuel cell comprising first and second anodes, first and second cathodes, and first and second polymer electrolyte membranes; electrocatalytically oxidizing a hydrogen source by a first catalyst disposed on the first anode to produce primary protons; electrocatalytically reducing the primary protons by a second catalyst disposed on the first cathode to produce hydrogen; controlling a provision of the hydrogen to a third catalyst disposed on the second anode; electrocatalytically oxidizing the hydrogen by the third catalyst to produce secondary protons; and electrocatalytically reducing a hydrocarbonaceous source by the secondary protons and a fourth catalyst disposed on the second cathode to produce a C₁-C₈ hydrocarbon, wherein the first, second, third, and fourth catalysts are each a solid catalyst, the first anode and first cathode are separated by the first polymer electrolyte membrane, the second anode and the second cathode are separated by the second polymer electrolyte membrane, and the first cathode and the second anode are separated by a hydrogen regulator to regulate pressure and flow of hydrogen gas.

In another embodiment, an energy storage system comprises a first fuel cell comprising: an anode; a cathode; a polymer electrolyte membrane; and a catalyst; and a second fuel cell coupled to the first fuel cell, wherein the first fuel cell is configured to oxidize hydrogen, to reduce a water-soluble carbohydrate, and to store energy from the reduction of the water-soluble carbohydrate in a fuel composition, the fuel composition being a C₁-C₈ alkane, a C₁-C₈ oxygenate, or a combination comprising at least one of the foregoing.

In another embodiment, an energy source, comprises a first fuel cell comprising: an anode; a cathode; and a polymer electrolyte membrane; and a shunt connected to the anode and the cathode; and a second fuel cell coupled to the first fuel cell; wherein the first fuel cell is configured to oxidize hydrogen, to reduce a water- soluble carbohydrate, and to store energy from the reduction of the water soluble- carbohydrate in a fuel composition, the fuel composition being a C₁-C₈ alkane, a C₁-C₈ oxygenate, or a combination comprising at least one of the foregoing, wherein the shunt is configured in a first state to electrically connect the anode and the cathode to reduce the carbohydrate; and in a second state to electrically connect the anode and the cathode across an electrical load to provide energy to the electrical load from oxidation of the fuel composition

### BRIEF DESCRIPTION OF THE DRAWINGS

FIG. 1 illustrates an exemplary hydrocarbon fuel cell according to the method;

FIG. 2 illustrates an exemplary combination of a hydrogen fuel cell feeding a hydrogen source into a hydrocarbon fuel cell, according to the method;

FIG. 3 illustrates a schematic of an exemplary permeable electrolytic membrane (PEM) reactor;

FIG. 4 illustrates current density and power input as a function of applied voltage for the electrocatalytic reduction of furfural to furfuryl alcohol and tetrahydrofurfuryl alcohol over Pd/C catalyst;

FIG. 5 illustrates current density and power input as a function of applied voltage for the electrocatalytic reduction of furfural to furfuryl alcohol and tetrahydrofurfuryl alcohol over Pt/C catalyst;

FIG. 6 illustrates current efficiency as a function of power input for the electrocatalytic reduction of furfural;

FIG. 7 illustrates reaction rate as a function of power input for the electrocatalytic reduction of furfural;

FIG. 8 illustrates selectivity as a function of conversion for the electrocatalytic reduction of furfural;

FIG. 9 illustrates reaction rate as a function of power input for the electrocatalytic reduction of furfural (the H₂O/furfural cathodic System) and the electrolysis of water to produce hydrogen gas (the H₂O/N₂ anodic system;

FIG. 10 illustrates current density and current efficiency as a function of temperature for the electrocatalytic reduction of furfural;

FIG. 11 illustrates reaction rate and power input as a function of temperature for the electrocatalytic reduction of furfural;

FIG. 12 illustrates reaction rate as a function of power input for the electrocatalytic reduction of furfuryl alcohol in a PEM reactor;

FIG. 13 illustrates selectivity as a function of power input for the electrocatalytic reduction of furfuryl alcohol in a PEM reactor; and

FIG. 14 illustrates current efficiency and reaction rate for the for the electrocatalytic reduction of furfural as a function of power input.

The above described and other features are exemplified by the following detailed description.

### DETAILED DESCRIPTION OF THE INVENTION

Disclosed herein is a method of electrocatalytically producing a hydrocarbon fuel from a sugar feedstock. The sugar feedstock is electrocatalytically reduced at the cathode of a fuel cell, coated with a catalyst to effect reduction of the sugars using a proton source provided by the anode, to provide as a storable energy medium a hydrocarbon fuel composition in a cost and space-efficient, combustible form, for later used.

The method includes electrocatalytically reducing a proton source, such as water, an alcohol, or hydrogen, to protons which are transferred across a polymer electrolyte membrane to the cathode of the fuel cell, and effecting reduction of a low- cost, readily available polyol feedstock such as a simple sugar (e.g., glucose or fructose). The reaction produces a recyclable stream of a carrier fluid (e.g., water) and a fuel composition (e.g., hexanes).

The method of producing a hydrocarbon includes providing electrical energy to a first fuel cell comprising an anode, cathode, and polymer electrolyte membrane. The fuel cell thus includes a polymer electrolyte membrane. Polymer electrolyte membranes allow the free passage of protons but do not allow the free passage of gases such as oxygen and nitrogen and keep the cathodic and anodic sides of the cell chemically separated. Exemplary polymer electrolyte membranes include, for example, those prepared from polyolefins such as polyethylene, polypropylene, poly(ethylene-propylene), fluorinated alkyl polymers, copolymers of the foregoing with (meth)acrylic acids and/or their esters, or a combination comprising at least one of the foregoing. Exemplary such membranes include polyethylenes, block copolymers of polyethylenes with (meth)acrylic acids, and poly(tetrafluoroethylene-(meth)acrylic acid) block copolymers such as those sold under the tradename NAFION™ by DuPont.

The anode of the fuel cell includes a catalyst disposed on a surface of the anode (i.e., the anodic catalyst), or is formed of a catalytic material for effecting reduction of a hydrogen source to provide protons for transmembrane transport. The catalytic material used in the anode is without limitation any material known to perform this function, such as any suitable transition metal of the Group 4-12 series, with a lower activity than that of the material of the cathode. Exemplary such materials include a metal comprising cobalt, chromium, iron, iridium, molybdenum, nickel, osmium, palladium, platinum, rhenium, rhodium, ruthenium, tin, tungsten, or a combination comprising at least one of the foregoing. In an embodiment, the exemplary materials are homogeneous catalysts, or are heterogeneous catalysts adsorbed on a support. The support may be any material suitable for supporting a catalyst, such as, for example, alumina, silica, carbon, clays, other metals, aluminosilicates including zeolites, and the like.

Thus, the method includes electrocatalytically oxidizing a hydrogen source by a catalyst disposed on the anode to produce protons. In an embodiment, the hydrogen source is a gas. In another embodiment, the hydrogen source is a liquid. The hydrogen source includes, in an embodiment, hydrogen, water, a C₁-C₆ alcohol, or a combination comprising at least one of the foregoing.

The cathode of the fuel cell also includes a catalyst disposed on a surface of the cathode (i.e., the cathodic catalyst). The anodic catalyst and the cathodic catalyst are not necessarily identical. The catalyst disposed on the cathode comprises a finely divided metal, with or without a support, capable of mediating reduction of carbinol functional groups in the presence of a proton source. Metals suitable for such catalytic activity include Group 4-12 metals, the lanthanides, or a combination thereof, and in particular, Group 4-10 metals. Particularly preferred metals for this use include those of the iron series, Groups 8-10. Exemplary metals include cobalt, chromium, iron, iridium, molybdenum, nickel, osmium, palladium, platinum, rhenium, rhodium, ruthenium, tin, tungsten, and a combination comprising at least one of the foregoing.

The anodic and cathodic catalysts may include a support on which the metal is coated. Catalyst supports include, for example, silica; alumina; zirconium phosphate; carbon such as carbon black, charcoal, activated carbon, or the like; aluminosilicates including both synthetic and mineral-based aluminosilicates such as zeolites, and clays such as for example montmorillonite, kaolinite, hallyosite, or the like; metal oxides such as zirconia, titania, hathia, zinc oxide, copper oxide, magnesium oxide, iron oxide, and magnesia; or a combination comprising at least one of the foregoing. Aluminosilicates, where used, include aluminum and silicon in a molar ratio of silica to alumina of about 1:10 to about 10:1, preferably about 2:1 to about 6:1, respectively.

In an embodiment, the catalyst coated on the cathode includes a metal comprising cobalt, chromium, iron, iridium, nickel, palladium platinum, rhenium, rhodium, ruthenium, osmium, tin, or a combination comprising at least one of the foregoing; and a support comprising carbon, silica-alumina or zirconium phosphate. Exemplary such catalysts include platinum on zirconium phosphate, platinum on silica- alumina, platinum-rhenium on carbon, or a combination comprising at least one of the foregoing.

Where a supported catalyst is used for the cathode, the metal is present in an amount of about 4 wt. % to about 20 wt. %, preferably about 4 wt. % to about 10 wt. %, and still more preferably about 4 wt % to about 8 wt %, based on the weight of the catalyst.

The fuel cell thus includes an anode for oxidizing a hydrogen source, a cathode including a catalyst for reducing a hydrocabonaceous source, and a polymer electrolyte membrane. The catalysts coating the anode and cathode are each solid catalysts, and the anode and cathode are separated by the polymer electrolyte membrane, which is disposed between opposing surfaces of the anode and the cathode.

The temperature of the fuel cell is about 25° C. to about 90° C., preferably about 30° C. to about 85° C., and more preferably about 40° C. to about 80° C. during the electrocatalytic oxidizing of the hydrogen source and the electrocatalytic reducing of the hydrocarbonaceous source. The pressure of the fuel cell is less than about 1 MPa, preferably about 0.1 MPa to about 0.7 MPa, and more preferably about 0.1 MPa to about 0.4 MPa during the reducing of the hydrocarbonaceous source.

In a further embodiment, the hydrogen source fed into the fuel cell may be generated in a second, hydrogen-producing fuel cell. Thus in an embodiment, the hydrogen source is provided by electrocatalytically electrolyzing water in a second fuel cell to produce hydrogen; and providing the hydrogen produced in the hydrogen- producing fuel cell to the fuel cell used to produce the hydrocarbon fuel composition. In this way, the hydrogen-producing fuel cell feeds the hydrogen source to the catalytic fuel cell without need for additional catalyst provided on the anode of the fuel cell for hydrocarbon production, and without need to store or otherwise provide a source of a combustible hydrogen source (e.g., hydrogen) in order to operate the fuel cell for hydrocarbon production.

The method also includes electrocatalytically reducing a hydrocarbonaceous source by the protons generated at the anode, with a catalyst disposed on a surface of the cathode, to produce a hydrocarbon fuel composition. In an embodiment, the hydrocarbonaceous source is a gas. In another embodiment, the hydrocarbonaceous source is a liquid. In an embodiment, the hydrocarbonaceous source includes a carbon chain and is at least partially oxygenated. For example, the hydrocarbonaceous source may be a compound comprising a hydroxyl group such as an alcohol, a polyol, a sugar, a starch, cellulose, or the like. In an exemplary embodiment, the hydrocarbonaceous source includes a biomass-derived compound including a water soluble (i.e., a polymeric high hydroxyl content) compound, a compound comprising a hydroxyl group, a compound comprising an ether group, or a combination comprising at least one of the foregoing.

Exemplary hydrocarbonaceous sources include bio-oil, carbohydrate, carboxylic acid, cellulose, furan, furfural, furfural alcohol, hemicellulose, lignin, a derivative thereof, or a combination comprising any of the foregoing. In a specific embodiment, the carbon source is a C₁-C₈ carbon source, preferably a C₃-C₆ carbon source, or is comprised of a carbohydrate comprising a monosaccharide, disaccharide, polysaccharide, sugar alcohol, starch, a derivative thereof, or a combination comprising any of the foregoing. Specific examples of such compounds include fructose, glucose, xylose, or a combination comprising at least one of the foregoing.

The hydrocarbonaceous source is fed to the fuel cell as a gas or as a solution, to allow free mixing and maximum control of surface contact time and space velocity with the catalyst bed. The hydrocarbonaceous source is preferably dissolved in a solvent that is non-reactive with the catalyst, i.e., so that the solvent does not itself convert to a different state but is neutral in reactivity toward the cathodic catalyst. Thus, in an embodiment, the hydrocarbonaceous source is dissolved in water to provide an aqueous solution of the hydrocarbonaceous source. In an embodiment, the hydrocarbonaceous source is water-soluble at a temperature of greater than or equal to about 5° C., preferably greater than or equal to about 10° C., and more preferably greater than or equal to about 15° C.

Also in an embodiment, the hydrocarbonaceous source solution is pH adjusted by addition of acid and/or base to the desired extent of acidity or basicity. The pH of the solution is 1 to 12, preferably 2 to 12, more preferably 3 to 10. In one embodiment, the pH of the solution is acidic (pH<7). In another embodiment, the pH of the solution is basic (pH>7). In another embodiment, the pH of the solution is preferably 8 or less, more preferably 1 to 8, and still more preferably 2 to 8. Adjustment of pH can be carried out by addition of any suitable acidic, basic, or buffering agent. Preferred acids include hydrochloric acid, sulfuric acid, nitric acid, formic acid, acetic acid, and the like; preferred bases include hydroxides such as sodium or potassium hydroxide, caustics such as sodium carbonate, bicarbonates such as sodium bicarbonate; bisulfates such as sodium or potassium bisulfate; combinations of these, or the like. Buffers include acetate buffers such as sodium acetate, phosphates including mono-, di-, and trisodium phosphate; citrates; tartrates; and the like. Additives may be included such as surfactants, leveling agents, complexing agents, and the like. It will be understood that the aforementioned acids, bases, buffers, and additives are exemplary and are not to be considered limiting to the skilled artisan. Further, addition of such additives is permissible where inclusion of these compounds provide no significantly adverse effect on the operation of the fuel cell and the production of the hydrocarbon fuel composition.

In addition, the hydrocarbonaceous source is present in a solution in an amount of about 0.1 wt. % to about 50 wt. %, preferably about 0.5 wt. % to about 40 wt. %, and more preferably about 1 wt. % to about 30 wt. % based on the weight of the solution.

The solution has a weight-hour space velocity of about 0.1 hr⁻¹ to about 1,000 hr⁻¹, preferably about 1 hr⁻¹ to about 750 hr⁻¹, and more preferably about 10 hr⁻¹ to about 500 hr⁻¹ in the first fuel cell.

It will be understood that after reduction at the cathode, the resulting hydrocarbon fuel composition can become immiscible with and separate from the hydrocarbonaceous source solution feed stream. As necessary, the streams are separated and the hydrocarbon fuel composition recycled through the fuel cell to further convert dissolved hydrocarbonaceous source. Additional such hydrocarbonaceous source may be added continuously to maintain a constant feed composition, or may be run continuously or sequentially to deplete the hydrocarbonaceous source solution of the hydrocarbonaceous source material.

After hydrocarbon fuel composition comprises a C₁-C₈ hydrocarbon. In an embodiment, the fuel composition is a gas. In another embodiment, the fuel composition is a liquid. Useful hydrocarbons for the fuel composition have a research octane number of about 80 to about 100, preferably about 85 to about 95, and are suitable for use in standard hydrocarbon fuel applications such as automotive fuel.

In an embodiment, herein hydrocarbon fuel product comprises methane, ethane, propanes, butanes, pentanes, hexanes, heptanes, octanes, or a combination of at least one of the foregoing. In another embodiment, the fuel source includes oxygenates, i.e., partially oxidized hydrocarbons for improving completeness of eventual combustion. Partial oxidation, as used herein, means including hydroxyl groups and/or ether groups, which form a portion of a fuel composition to provide partial oxidation to the fuel composition. In an embodiment, a C₁-C₈ oxygenate is derived from electrocatalytically reducing the hydrocarbonaceous source.

The method further includes reacting a portion of the hydrocarbon fuel composition to produce energy. In this way, the resultant hydrocarbon fuel composition produced can be used to power the energy needs of the fuel cell(s) (i.e., the hydrocarbon- producing fuel cell and/or optional hydrogen fuel cell acting as a hydrogen source for the hydrocarbon-producing fuel cell), and be used to generate electrical and/or thermal energy for other uses.

Conversion of the hydrocarbon fuel composition (stored energy) to electrical energy is advantageously carried out during peak time. Where the energy storage system is in use, the electrical energy is stored as chemical energy in the fuel composition during off-peak time. Thus, provision of electrical energy to the fuel cells is during an off-peak time, so that the electrical energy is stored as chemical energy in the fuel composition. Providing electrical energy to the fuel cells is, in an embodiment, from a renewable source comprising an agricultural source, geothermal source, hydroelectric source, solar source, tidal source, wind source, or a combination comprising at least one of the foregoing, and the electrical energy is stored as chemical energy in the fuel composition. In this way, the maximum amount of stored energy in the form of fuel composition may be obtained.

The efficiency of the method is derived by considering the number of moles of total fuel composition that is produced, the number of moles of the hydrocarbonaceous source, the heating energy of these materials, and the electrical power input. Additional independent claims can recite different species of the fuel composition. The overall efficiency will depend upon variables including the weight-hour space velocity (WHSV), fuel cell operating temperature, and fuel cell operating pressure. Additional variables include the nature of the hydrocarbonaceous source and purity, concentration, pH, and catalyst. Thus, electrocatalytically reducing the hydrocarbonaceous source produces the fuel composition with an efficiency of 55% where hydrogen is used as the hydrogen source, and 10% where water is used as the hydrogen source. It will be further understood that the space velocity of the feed solution, and the operating temperature and current and concentrations of the fuel cell will each be adjusted to provide the desired hydrocarbon fuel composition as a product, in an optimum efficiency.

In other embodiments, a method of producing a hydrocarbon includes providing electrical energy to a hydrogen-producing fuel cell comprising a first anode, first cathode, and first polymer electrolyte membrane, electrocatalytically oxidizing a hydrogen source by a catalyst disposed on the first anode to produce protons, electrocatalytically reducing the protons by a second catalyst disposed on the first cathode to produce hydrogen, providing the hydrogen from the hydrogen-producing fuel cell to a hydrocarbon fuel cell comprising a second anode, second cathode, and second polymer electrolyte membrane, providing electrical energy to the second fuel cell, electrocatalytically oxidizing the hydrogen by a third catalyst disposed on the second anode to produce protons, and electrocatalytically reducing a hydrocarbonaceous source by the protons and a fourth catalyst disposed on the second cathode to produce a fuel composition comprising a C₁-C₈ hydrocarbon. In this embodiment, the first, second, third, and fourth catalysts are each a solid catalyst, the first anode and first cathode are separated by the first polymer electrolyte membrane, and the second anode and second cathode are separated by the second polymer electrolyte membrane.

In another embodiment, producing a hydrocarbon includes providing electrical energy to a fuel cell comprising first and second anodes, first and second cathodes, and first and second polymer electrolyte membranes; electrocatalytically oxidizing a hydrogen source by a first catalyst disposed on the first anode to produce primary protons; electrocatalytically reducing the primary protons by a second catalyst disposed on the first cathode to produce hydrogen; controlling a provision of the hydrogen to a third catalyst disposed on the second anode; electrocatalytically oxidizing the hydrogen by the third catalyst to produce secondary protons; and electrocatalytically reducing a hydro carbonaceous source by the secondary protons and a fourth catalyst disposed on the second cathode to produce a C₁-C₈ hydrocarbon. In an embodiment, the first, second, third, and fourth catalysts are each a solid catalyst, the first anode and first cathode are separated by the first polymer electrolyte membrane, the second anode and the second cathode are separated by the second polymer electrolyte membrane, and the first cathode and the second anode are separated by a hydrogen regulator designed to regulate pressure and flow of hydrogen gas. Exemplary hydrogen regulators may include an aperture, a tube, a valve, a membrane, or a metallic mesh.

In another embodiment, an energy storage system includes a first fuel cell including an anode, a cathode, a polymer electrolyte membrane, and a catalyst; and a second fuel cell coupled to the first fuel cell, wherein the first fuel cell is configured to oxidize hydrogen, to reduce a water-soluble carbohydrate, and to store energy from the reduction of the water-soluble carbohydrate in a fuel composition, the fuel composition being a C₁-C₈ alkane, a C₁-C₈ oxygenate, or a combination comprising at least one of the foregoing. In a further embodiment, the second fuel cell is a hydrogen fuel cell configured to provide hydrogen to the first fuel cell from electrolysis of water. The catalyst is platinum, palladium, rhenium, or a combination comprising at least one of the foregoing, and is disposed on a support, the support being silica-alumina, zirconium phosphate, carbon, or a combination comprising at least one of the foregoing.

In another embodiment, an energy source includes a first fuel cell comprising an anode, a cathode, and a polymer electrolyte membrane; and a shunt connected to the anode and the cathode; and a second fuel cell coupled to the first fuel cell. The first fuel cell is configured to oxidize hydrogen, to reduce a water-soluble carbohydrate, and to store energy from the reduction of the water soluble-carbohydrate in a fuel composition, the fuel composition being a C₁-C₈ alkane, a C₁-C₈ oxygenate, or a combination comprising at least one of the foregoing. The shunt is configured in a first state to electrically connect the anode and the cathode to reduce the carbohydrate; and in a second state to electrically connect the anode and the cathode across an electrical load to provide energy to the electrical load from oxidation of the fuel composition. In a further embodiment, the second fuel cell is a hydrogen fuel cell configured to provide the hydrogen to the first fuel cell from electrolysis of water, and the carbohydrate is a C₄ to C₈ monosaccharide, C₄ to C₈ sugar alcohol, or a combination comprising at least one of the foregoing.

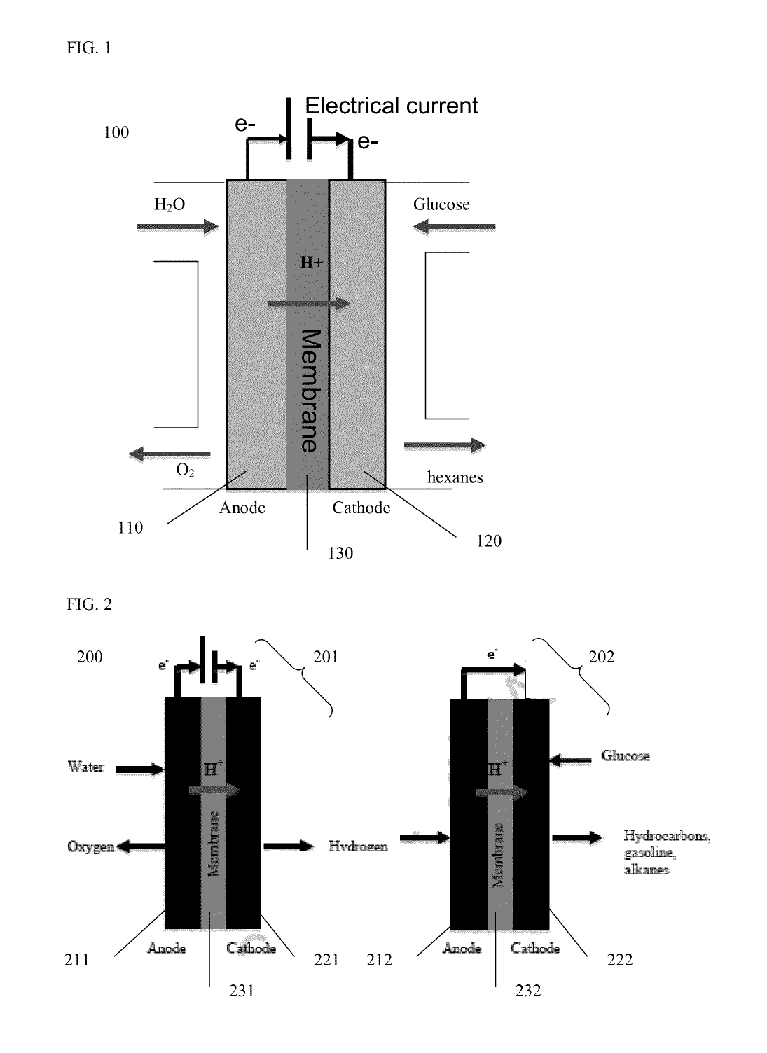

Exemplary embodiments are described in the Figures. FIG. 1 shows a first embodiment of a fuel cell 100 used in the method. In FIG. 1, the anode 110 and cathode 120 are separated by a polymeric membrane separator 130. The cathode 120 is coated with a catalyst (not shown). When electrical current is applied across the anode and cathode, water inputted into the system (left hand side of cell 100) is reduced to protons and oxygen gas, and a sugar such as glucose, inputted into the system (right hand side of cell 100) is reduced from a hydroxide form to an alkane form (e.g., hexanes).

FIG. 2 shows another embodiment of a fuel cell apparatus 200 which uses two fuel cells, a hydrogen-producing fuel cell 201 and a hydrocarbon producing fuel cell 202. The hydrogen-producing fuel cell 201 includes anode 211, cathode 221, and polymer electrolyte membrane 231. The anode 211 and cathode 221 are separated by a polymeric membrane separator 231. When electrical current is applied across the anode and cathode of cell 201, water inputted into cell 201 (left hand side of cell 100) is reduced to protons and oxygen gas, and the protons are reduced (right hand side) to provide hydrogen gas as an output. Further in FIG. 2, the hydrocarbon fuel cell 202 receives as input the hydrogen gas provided by cell 201 as a hydrogen source. Fuel cell 202 includes anode 211 and cathode 221 which are separated by a polymeric membrane separator 231. The cathode 221 is coated with a catalyst (not shown). When electrical current is applied across the anode and cathode, hydrogen inputted into the system from cell 201 (left hand side of cell 202) is reduced to protons and oxygen gas, and a sugar such as glucose, inputted into the system (right hand side of cell 202) is reduced from a hydroxide form to an alkane form (e.g., hexanes).

The invention is further illustrated by the following examples. All compounds and reagents used herein are available commercially.

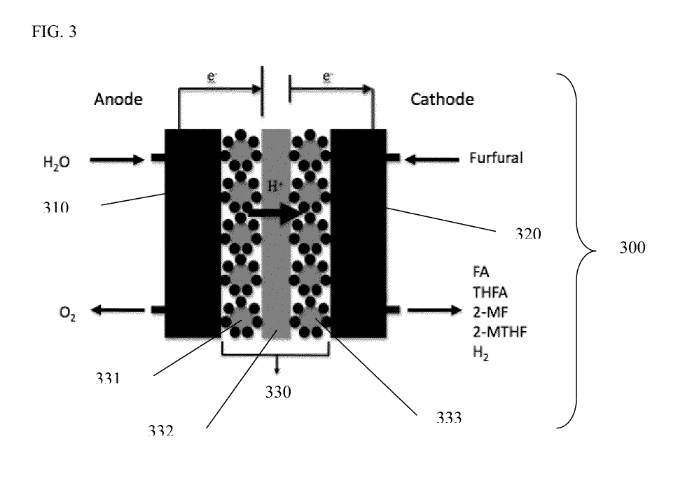

Example. Electro catalytic reduction of furfural. Electro catalytic reduction of furfural was carried out as follows. FIG. 3 illustrates the permeable electrolytic membrane (PEM) reactor used for electrocatalytic reduction of furfural. The reactor included an anode (310) and cathode (320), a membrane electrode assembly (330) formed of a Pt—Ru/C catalyst (331) contacting the anode (310), a NAFION™ membrane (332), and a Pt/C or Pd/C catalyst (333) contacting the cathode (320). The anode 310 was configured to allow aqueous fluid flow through an inlet, through the Pt—Ru/C catalyst bed (331), and to an outlet without crossing the membrane (332) to the cathode (333). Similarly, the cathode (320) was configured to allow fluid flow through an inlet, through the Pt/C or Pd/C catalyst bed (333), and to an outlet without crossing the membrane (332) to the anode (310).

A solution of 5 wt % furfural in water was introduced to the cathode 320 via the cathode inlet, and passed through Pt/C or Pd/C catalyst bed 233, with an aqueous solution of products exiting. Products of the reduction of furfural and analyzed for included furfuryl alcohol (FA), 2-methylfuran (MF), tetrahydrofurfuryl alcohol (THFA), and 2-methyltetrahydrofuran (MTHF). Product composition and concentration was determined by gas chromatography with mass spectrometry detection (GC/MS). Simultaneously, water or hydrogen gas as a proton source for cross-membrane proton transfer reduction of the furfural was passed through the catalyst bed 331.

Reactor temperature was maintained at a temperature of 30° C. except as noted below. The cathode conditions included a flow rate of 111.7 WHSV furfural over a catalyst bed of Pd/C or Pt/C at a catalyst loading of 1.0 mg/cm². The anode conditions included a flow of deionized H₂O (18 mI)/cm) at a flow rate of 0.6 ml/min over a Pt—Ru/C catalyst bed at a loading of 4.0 mg/cm².

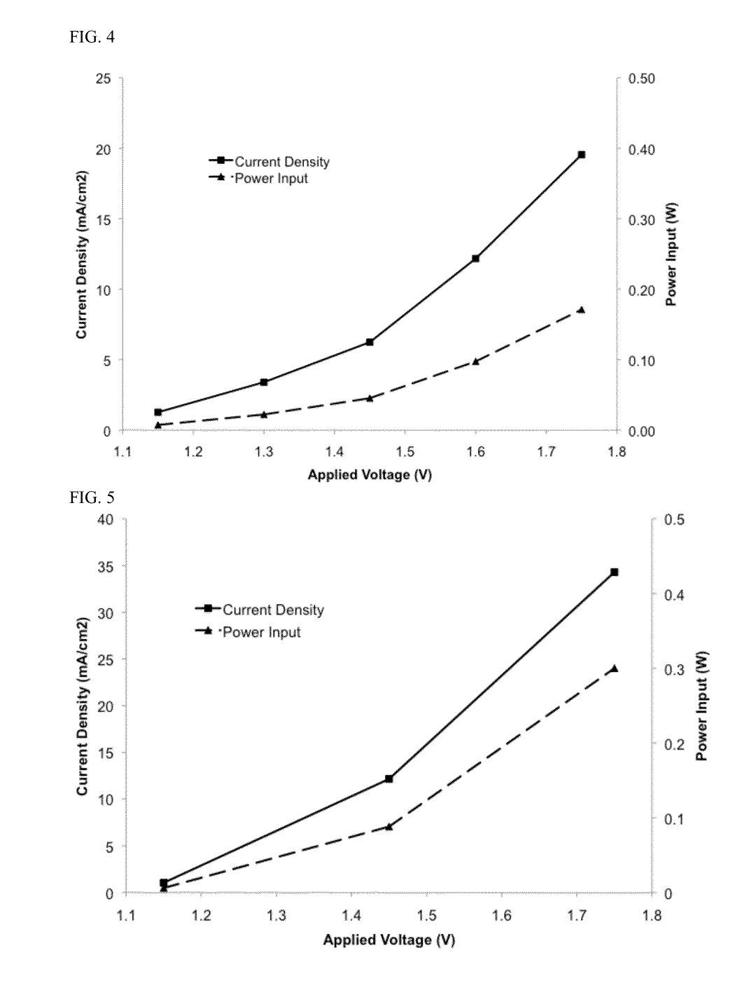

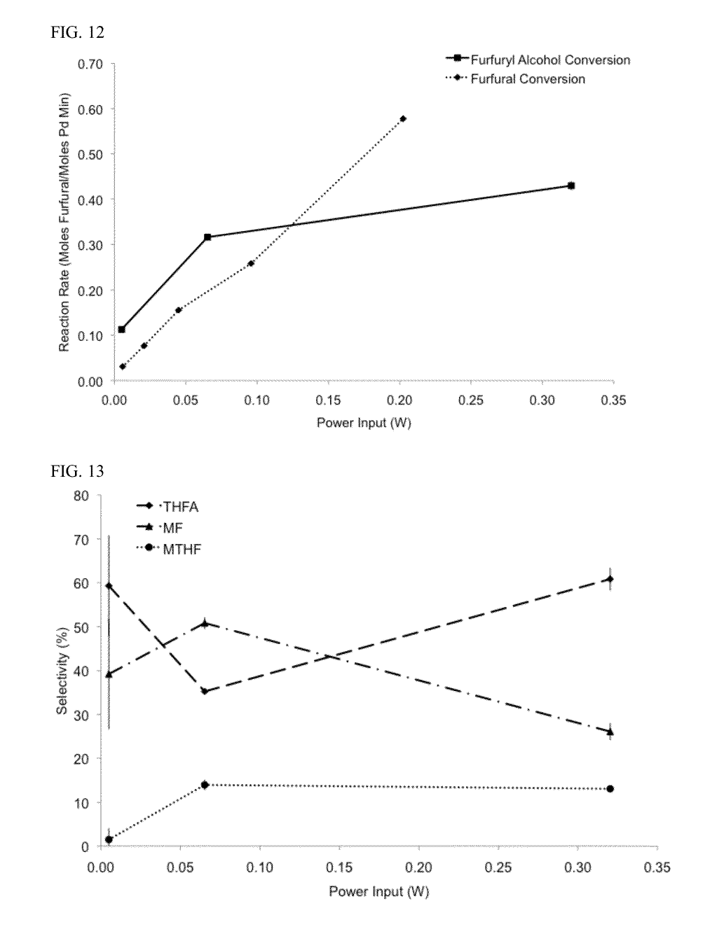

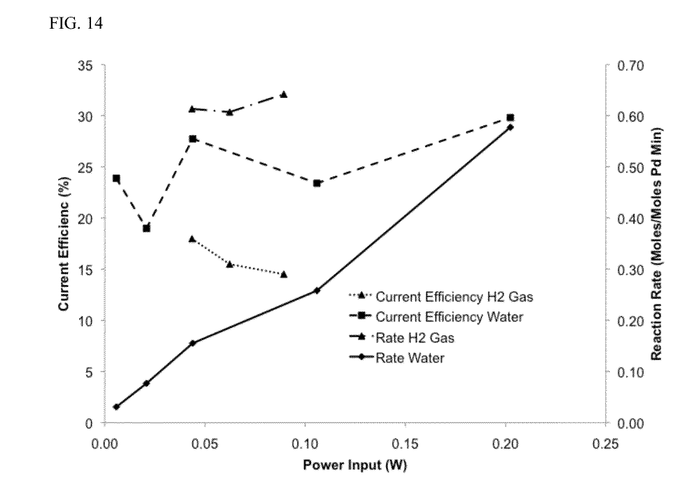

Power input (voltage) was varied from 1.15V to 1.75V with a current flux of 0 to 20 mA/cm² for Pd/C catalyst (FIG.4A) and 0 to 35 mA/cm² for Pt/C (FIG. 4B) across the anode/cathode to effect electrocatalytic reduction of furfural to furfuryl alcohol and tetrahydrofurfuryl alcohol.

FIGS. 4A and 4B are plots of current density and power input as a function of applied voltage for both Pd/C (FIG. 4A) and Pt/C (FIG. 4B) cathode catalysts. Both current density and power input are higher for Pt/C than for Pd/C. These variables translate directly to the flux of protons through the MEA, as determined by the Faraday constant. Thus, Pt/C produces a higher flux of protons from the anode to the cathode than does Pd/C.

Current efficiency and reaction rate as a function of power input are shown in FIGS. 5A and 5B, respectively, for the electrocatalytic reduction of furfural. As seen in the figures, Pt/C is less efficient than Pd/C at using protons to produce FA or THFA. The current efficiency for the electrocatalytic reduction of furfural over Pd/C indicates that selectivity towards desired liquid products ranges from 18-30%. Protons not contributing to furfural hydrogenation instead evolve into undesired hydrogen gas at the cathode. No MF or MTHF was detected from furfural hydrogenation over Pt/C, and THFA was only present at a power input of 0.3W.

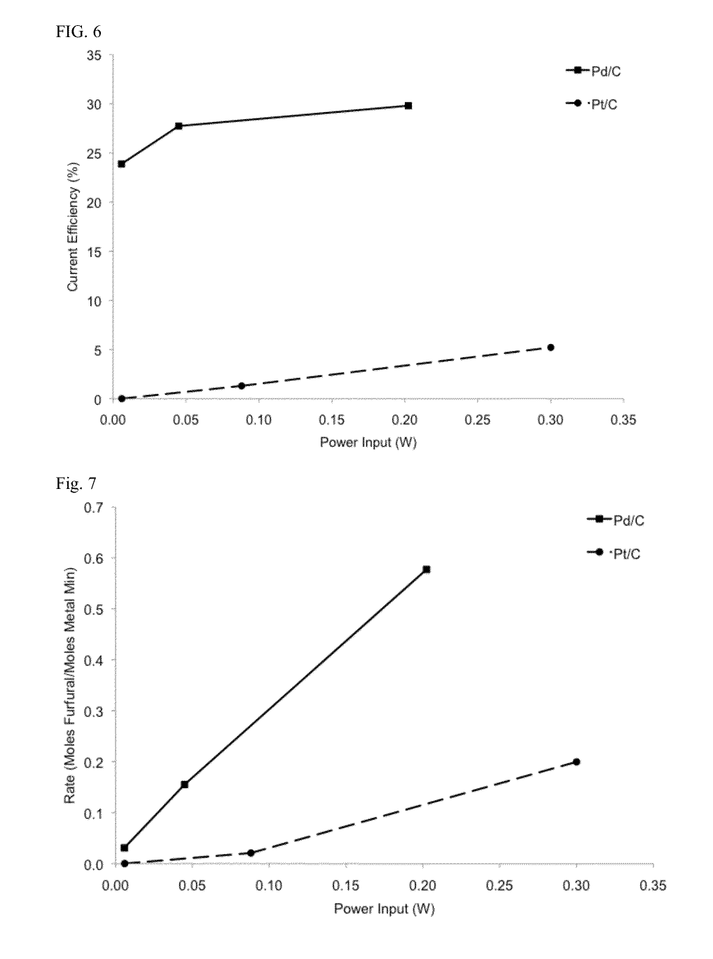

Effect of Applied Voltage. The effect of applied voltage on reaction rate, selectivity, and current efficiency was investigated over a range of 1.15V to 1.75V. The cell current varied along with voltage, and thus results are presented as a function of total power input. FIG. 6 depicts the change in liquid product selectivity as a function of power input for furfural hydrogenation. FA was the main product with 100% selectivity at 0.01W, and 54% at 0.2 W. THFA was the second most abundant product with a selectivity of 26% at 0.2 W. Selectivity towards MF and MTHF was approximately 8%, each, irrespective of power input after ˜0.05 W. Overall, these results signify that at least 0.05 W of power input are required to produce secondary products from furfural hydrogenation.

In FIG. 7, the rate of hydrogen production and furfural conversion is shown comparatively as a function of power input for two different systems: 1) for H₂O on the anode/furfural on the cathode (the H₂O/furfural system); and 2) H₂O on the anode/N₂ on the cathode (the H₂O/N₂ system). Hydrogen gas was collected at the cathode by sparging the liquid product with nitrogen gas. The highest measured rate of hydrogen production was from the H₂O/N₂ system. At power inputs of less than 0.05 W, the H₂O/furfural system had comparable rates of hydrogen production. However, as the power input increases, the rate of hydrogen production for the H₂O/furfural system decreased compared to hydrogen production by the H₂O/N₂ system. The rate of furfural conversion in the H₂O/furfural system increases with increasing power input, but is as much as 16 times lower than hydrogen production in the same system. Also shown in FIG. 7 is the rate of hydrogen production plus the rate of furfural conversion for the H₂O/furfural system. This combined rate is similar to the rate of hydrogen production in the H₂O/N₂ system, especially for power inputs below 0.1 W. Thus at power inputs below 0.1 W, furfural does not inhibit the rate of water electrolysis.

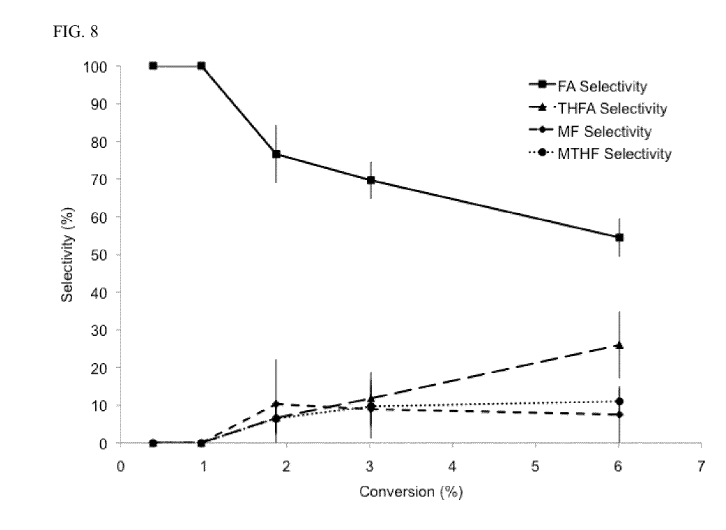

Effect of Reactor Temperature. Reactor temperature was increased from 30° C. to 70° C. to determine the effect on the reaction rate for furfural hydrogenation. Current density and power input both increased with increasing temperature, but current efficiency decreased and there was no change in production of either FA or THFA. FIGS. 8A and 8B illustrate these effects.

As seen in FIG. 8A, the increase in temperature promotes water electrolysis, as evidenced by the increase in current density, and production of hydrogen gas, as evidenced by the decrease in current efficiency. The increase in hydrogen gas relative to furfural hydrogenation products in also seen in FIG, 8B, where the increase in temperature does not produce a change in the production of either FA or THFA.

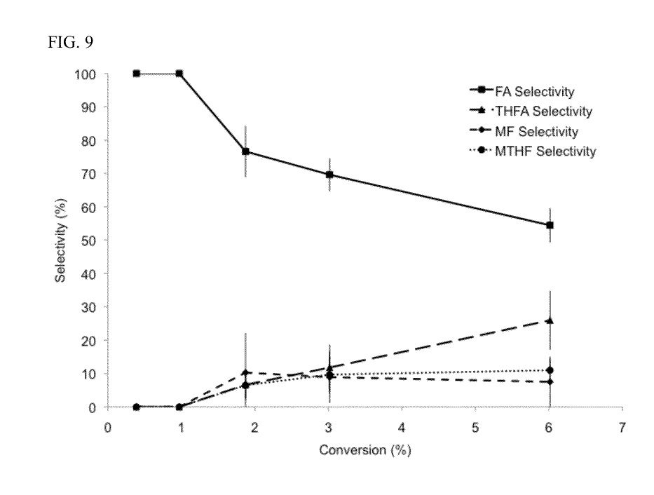

Electrocatalytic Reduction of Furfuryl Alcohol. The electrocatalytic hydrogenation of FA was investigated to further study reaction rates and selectivity for furfural hydrogenation. FA conversion rate increased with increasing power input (FIG. 9A), but not in the same manner as furfural conversion (included in the same Figure). The initial FA conversion rate is higher than furfural conversion; however, at power inputs greater than 0.12 W furfural conversion is higher. This could be because furfural must first be converted to FA before secondary products, while FA can immediately convert to both THFA and MF.

As seen in FIG. 9B, the main products of FA hydrogenation are THFA and MF. Selectivity towards MF is significantly higher (approximately 28-50%) than during furfural conversion (<10%). Without wishing to be bound by theory, this suggests that furfural hydrogenation at power inputs below 0.05 W could form THFA and MF, but that insufficient FA is present for additional hydrogenation. A small increase in power input causes MF to be the main product; however, a large increase in power input again promotes THFA. This may indicate that MF is the intermediate for MTHF formation, rather than THFA.

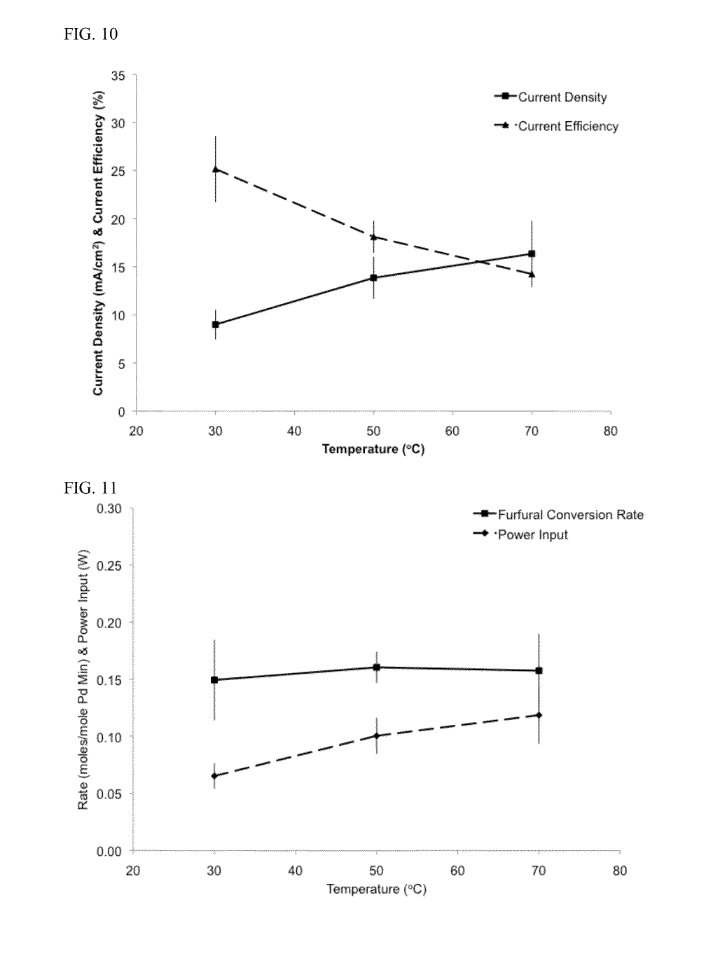

Electrocatalytic Reduction using Hydrogen Gas. FIG. 10 compares the hydrogenation of furfural using hydrogen gas to the hydrogenation of furfural using water electrolysis. Comparable rates can be achieved using either source of protons; however, hydrogen gas produces higher reaction rates at lower power inputs.

Further, electrocatalytic hydrogenation using hydrogen gas shows very little variation in reaction rate as a function of applied voltage, as compared to using water electrolysis. Electrocatalytic hydrogenation using hydrogen gas also has a lower current efficiency than when using water electrolysis. Selectivity towards THFA is slightly higher (31-20% compared to 5-10%, respectively) and towards FA is lower (58-66% compared to 75-74%, respectively).

It is thus seen that in the electrocatalytic reduction of furfural, the identified products were FA at ˜60-100% and THFA at 0-37% with MF and MTHF at ˜8% each. Pd/C is shown to be a more active cathode catalyst in the electrocatalytic hydrogenation of furfural than Pt/C. Varying the reactor temperature between 30° C. and 70° C. has minimal effect on reaction rate for furfural conversion. Using hydrogen gas in place of water electrolysis produces similar rates but at lower power inputs.

The singular forms “a,” “an,” and “the” include plural referents unless the context clearly dictates otherwise. Unless defined otherwise, technical and scientific terms used herein have the same meaning as is commonly understood by one of skill in the art to which this invention belongs. The endpoints of all ranges directed to the same component or property are inclusive and independently combinable. The suffix “(s)” as used herein is intended to include both the singular and the plural of the term that it modifies, thereby including at least one of that term. “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A method of producing a hydrocarbon comprising:
providing electrical energy to a first fuel cell comprising an anode, cathode, and polymer electrolyte membrane;
electrocatalytically oxidizing a hydrogen source by a first catalyst disposed on the anode to produce protons; and
electrocatalytically reducing a hydrocarbonaceous source by the protons and a second catalyst disposed on the cathode to produce a hydrocarbon fuel composition,
wherein the first and second catalysts are each a solid catalyst, and the anode and cathode are separated by the polymer electrolyte membrane.

2. The method of claim 1, wherein the hydrocarbonaceous source is a biomass- derived compound, a compound comprising a hydroxyl group, a compound comprising an ether group, or a combination comprising at least one of the foregoing.

3. The method of claim 2, wherein the hydrocarbonaceous source is a bio-oil, carbohydrate, carboxylic acid, cellulose, furan, furfural, furfural alcohol, hemicellulose, lignin, a derivative thereof, or a combination comprising any of the foregoing.

4. The method of claim 3, wherein the carbohydrate is a monosaccharide, disaccharide, polysaccharide, sugar alcohol, starch, a derivative thereof, or a combination comprising any of the foregoing.

5. The method of claim 4, wherein the carbohydrate is fructose, glucose, xylose, or a combination comprising at least one of the foregoing.

6. The method of claim 2, wherein the hydrocarbonaceous source is water-soluble at a temperature of at least about 5° C.

7. The method of claim 2, wherein the hydrocarbonaceous source is present in a solution in an amount of about 0.1 wt. % to about 50 wt. % based on the weight of the solution.

8. The method of claim 8, wherein the solution has a weight hour space velocity of about 0.1 hr⁻¹ to about 1,000 hr⁻¹ in the first fuel cell.

9. The method of claim 1, wherein the hydrocarbon fuel composition comprises a C₁-C₈ hydrocarbon.

10. The method of claim 9, wherein hydrocarbon fuel product comprises methane, ethane, propanes, butanes, pentanes, hexanes, heptanes, octanes, or a combination of at least one of the foregoing.

11. The method of claim 1, wherein the fuel composition has a research octane number of about 80 to about 100.

12. The method of claim 1, further comprising producing a C₁-C₈ oxygenate from the electrocatalytically reducing the hydrocarbonaceous source.

13. The method of claim 1, wherein the hydrogen source is hydrogen, water, a C₁-C₆ alcohol, or a combination comprising at least one of the foregoing.

14. The method of claim 1, further comprising:
electrocatalytically electrolyzing water in a second fuel cell to produce hydrogen; and
providing the hydrogen produced in the second fuel cell to the first fuel cell.

15. The method of claim 1, wherein the second catalyst comprises a metal disposed on a support comprising a Brønsted acid site.

16. The method of claim 1, wherein the second catalyst comprises:
a metal comprising cobalt, chromium, iron, iridium, molybdenum, nickel, osmium, palladium, platinum, rhenium, rhodium, ruthenium, tin, tungsten, or a combination comprising at least one of the foregoing; and
a support comprising silica, alumina, zirconium phosphate, carbon, zeolite, zirconia, titania, hafnia, zinc oxide, copper oxide, magnesium oxide, iron oxide, magnesia, or a combination comprising at least one of the foregoing.

17. The method of claim 16, wherein the second catalyst is platinum on zirconium phosphate, platinum on silica-alumina, platinum-rhenium on carbon, or a combination comprising at least one of the foregoing.

18. The method of claim 17, wherein the platinum is present in an amount of about 4 wt. % to about 20 wt. % based on the weight of the second catalyst, and
the support of the second catalyst is carbon, silica-alumina, or zirconium phosphate.

19. The method of claim 1, wherein the first catalyst comprises a metal comprising cobalt, chromium, iron, iridium, nickel, palladium platinum, rhenium, rhodium, ruthenium, osmium, tin, or a combination comprising at least one of the foregoing.

20. The method of claim 1, wherein a temperature of the first fuel cell is about 25° C. to about 90° C. during the electrocatalytic oxidizing of the hydrogen source and the electrocatalytic reducing of the hydrocarbonaceous source.

21. The method of claim 1, wherein the pressure of the first fuel cell is about 0.1 MPa to about 0.7 MPa during the reducing of the hydrocarbonaceous source.

22. The method of claim 1, further comprising reacting a portion of the fuel composition to produce energy.

23. The method of claim 1, wherein the providing of electrical energy is during an off-peak time, and the electrical energy is stored as chemical energy in the fuel composition.

24. The method of claim 1, wherein the providing of electrical energy is from a renewable source comprising an agricultural source, geothermal source, hydroelectric source, solar source, tidal source, wind source, or a combination comprising at least one of the foregoing, and
the electrical energy is stored as chemical energy in the fuel composition.

25. The method of claim 1, wherein the hydrogen source is a gas.

26. The method of claim 1, wherein the hydrogen source is a liquid.

27. The method of claim 1, wherein the hydrocarbonaceous source is a gas.

28. The method of claim 1, wherein the hydrocarbonaceous source is a liquid.

29. The method of claim 1, wherein the fuel composition is a gas.

30. The method of claim 1, wherein the fuel composition is a liquid.

31. The method of claim 1, wherein the electrocatalytic reducing of the hydrocarbonaceous source produces the fuel composition with an efficiency of 55% where hydrogen is used as the hydrogen source, and 10% where water is used as the hydrogen source.

32. A method of producing a hydrocarbon comprising:
providing electrical energy to a first fuel cell comprising a first anode, first cathode, and first polymer electrolyte membrane;
electrocatalytically oxidizing a hydrogen source by a first catalyst disposed on the first anode to produce protons;
electrocatalytically reducing the protons by a second catalyst disposed on the first cathode to produce hydrogen;
providing the hydrogen from the first fuel cell to a second fuel cell comprising a second anode, second cathode, and second polymer electrolyte membrane;
providing electrical energy to the second fuel cell;
electrocatalytically oxidizing the hydrogen by a third catalyst disposed on the second anode to produce protons; and
electrocatalytically reducing a hydrocarbonaceous source by the protons and a fourth catalyst disposed on the second cathode to produce a fuel composition comprising a C₁-C₈ hydrocarbon,
wherein the first, second, third, and fourth catalysts are each a solid catalyst,
the first anode and first cathode are separated by the first polymer electrolyte membrane, and
the second anode and second cathode are separated by the second polymer electrolyte membrane.

33. A method of producing a hydrocarbon comprising:
providing electrical energy to a fuel cell comprising first and second anodes, first and second cathodes, and first and second polymer electrolyte membranes;
electrocatalytically oxidizing a hydrogen source by a first catalyst disposed on the first anode to produce primary protons;
electrocatalytically reducing the primary protons by a second catalyst disposed on the first cathode to produce hydrogen;
controlling a provision of the hydrogen to a third catalyst disposed on the second anode;
electrocatalytically oxidizing the hydrogen by the third catalyst to produce secondary protons; and
electrocatalytically reducing a hydrocarbonaceous source by the secondary protons and a fourth catalyst disposed on the second cathode to produce a C₁-C₈ hydrocarbon,
wherein the first, second, third, and fourth catalysts are each a solid catalyst,
the first anode and first cathode are separated by the first polymer electrolyte membrane,
the second anode and the second cathode are separated by the second polymer electrolyte membrane, and
the first cathode and the second anode are separated by a hydrogen regulator to regulate pressure and flow of hydrogen gas.

34. An energy storage system comprising:
a first fuel cell comprising:
an anode;
a cathode;
a polymer electrolyte membrane; and
a catalyst; and
a second fuel cell coupled to the first fuel cell,
wherein the first fuel cell is configured to oxidize hydrogen, to reduce a water-soluble carbohydrate, and to store energy from the reduction of the water-soluble carbohydrate in a fuel composition, the fuel composition being a C₁-C₈ alkane, a C₁-C₈ oxygenate, or a combination comprising at least one of the foregoing.

35. The energy storage system of claim 34, wherein the second fuel cell is a hydrogen fuel cell configured to provide the hydrogen to the first fuel cell from electrolysis of water.

36. The energy storage system of claim 34, wherein the catalyst is platinum, palladium, rhenium, or a combination comprising at least one of the foregoing disposed on a support, the support being silica-alumina, zirconium phosphate, carbon, or a combination comprising at least one of the foregoing.

37. An energy source, comprising:
a first fuel cell comprising:
an anode;
a cathode; and
a polymer electrolyte membrane; and
a shunt connected to the anode and the cathode; and
a second fuel cell coupled to the first fuel cell;
wherein the first fuel cell is configured to oxidize hydrogen, to reduce a water- soluble carbohydrate, and to store energy from the reduction of the water soluble- carbohydrate in a fuel composition, the fuel composition being a C₁-C₈ alkane, a C₁-C₈ oxygenate, or a combination comprising at least one of the foregoing,
wherein the shunt is configured:
in a first state to electrically connect the anode and the cathode to reduce the carbohydrate; and
in a second state to electrically connect the anode and the cathode across an electrical load to provide energy to the electrical load from oxidation of the fuel composition.

38. The energy source of claim 37, wherein the second fuel cell is a hydrogen fuel cell configured to provide the hydrogen to the first fuel cell from electrolysis of water, and the carbohydrate is a C₄ to C₈ monosaccharide, C₄ to C₈ sugar alcohol, or a combination comprising at least one of the foregoing.
